(19) United States
(12) Patent Application Publication
(10) Pub. No.: US 2012/0116853 A1
(43) Pub. Date: May 10, 2012

(54) SYSTEM AND PROCESS FOR EVALUATION OF ATHLETE PERFORMANCE

(76) Inventor: SAMIR HANNA SAFAR, SAN DIEGO, CA (US)

(21) Appl. No.: 12/942,150

(22) Filed: Nov. 9, 2010

(51) Int. Cl. G06Q 10/00

(52) U.S. Cl. 705/7.42

(57) ABSTRACT

A system and process for evaluation of athlete performance where the player performance can be evaluated to form a score, ranking, and position and used for any kind of sport and to measure an individual or the entire team as one unit. A user or a team has to answer a set of questions specifically to that sport or specifically to the athlete role/position on the team. Based on those questions, through complex logic the present invention calculates a score and exhibit on a chart for visual presentation. For each question a unit called “Data Field” is formed comprising of logical and mathematical calculation. Each data field is added and the athlete level or score of performance will be displayed visually on graph. The present invention measures the athlete's present performance based on various points and is not entirely based on his past record.

### FIELD OF THE INVENTION

The present invention relates to the field of systems for performance evaluation, and more particularly to a system and process for measuring individual athlete performance and team performance through logical and mathematical data entry, analysis and calculation.

### BACKGROUND OF THE INVENTION

Athletes constantly strive to improve their time, perfect their technique, or improve their focus. For many sports, the origin of science-based training seemed to come from adaptations of existing technology that were applied to the sport.

Many players-athletes and teams have little or no experience in performance analysis and evaluations. Factors such as a lack of adequate systems and the difficulty of the existing processes are age-old complaints from athletes.

Athlete Performance is all about achieving peak performance in an athlete via biomechanical and performance analysis to identify of scoring issues to maximise performance and to prevent injuries. Once an athletes biomechanical and performance issues that are affecting their peak performance are identified, the athlete's performance can be evaluated as a comprehensive assessment report detailing recommendations on key areas that need to be targeted in order to achieve performance goals and/or prevent or resolve injuries. Athlete Performance can also then individually design and implement a comprehensive training program in order to achieve peak performance goals.

Performance is an assessment of how well a task is executed and the success of an evaluation is largely dependent upon satisfying the performance aims associated with it. Various components of an evaluation additionally break up, and increase the exactness of the evaluation. Elements to be considered are pre race preparations, athletic record, physical and medical condition, team and coach relationships, focus and performance plans and achievement of these plans. An evaluation form is useful to help the athlete and coach conduct this review. Assigning numerical measures to various aspects of a player's performance is a convenient and perhaps useful, if not completely defensible, practice. A numerical measure certainly eases the problem of rank ordering players.

The relevant prior art methods, which will deal with evaluating and monitoring athlete performances, are as follows:

U.S. Pat. No. 5,479,592 describes a method of simultaneously analyzing a plurality of performance statistics of an athlete. This invention relates to the analysis of sports statistics and method of determining performance characteristics of an athlete. The athlete's performance are determined from the graph by determining the position (vertical and horizontal) of the grid with respect to the origin of the graph the size (height and width) of the grid, and shape (square, tall and thin, or short and wide) of the grid, each aspect of the grid defining a different performance characteristic. The two-dimensional format of the performance grid is easily interpreted, and readily comparable with the performance grids of other athletes. The performance grid allows the viewer to determine, at a single glance, multiple performance characteristics of an athlete, without the need to individually compare and interpret burdensome statistical numbers.

U.S. Pat. No. 5,897,457 claims an athletic performance monitoring system. The present invention determines the time lapse between the athletes presence being sensed and calculates a performance value, such as jump height, leg power, or time over an interval after a signal is given. A light emitting diode (LED) may be included in the apparatus to signal the athlete to begin performance while simultaneously starting the timing function. In operation, the athlete jumps and the ultrasonic sensor signal the microprocessor to begin the timing function and the vibration sensor sends a second signal to stop the timing function when the athlete lands again. The interval between signals is used in distance formula h=g (I/2).sup.2/2 to determine the height attained and a display is provided for a human sensible output to show the athlete or evaluation personnel the height of the jump. Various types of sensors are anticipated in the device to start and stop the timing function.

U.S. Pat. No. 6,585,622 describes an athletic performance monitoring and reward method, system, and computer program product. The present invention is directed to a method and system for monitoring athletic performance and rewarding that performance to thereby motivate the athlete. A system and a method for measuring, tracking, and recording the athletic performance of an athlete using a remote device; transferring that data from the remote device to a common location, such as an Internet web site server; calculating, assigning, and tracking rewards based on the level of athletic performance determined from the data; and allowing the athlete to benefit from his or her earned rewards or compare his or her performance level with other athletes using other remote devices.

U.S. Pat. No. 7,072,789 claims a system for assessing athletic performance. A system for comparing athletic performance between multiple persons, comprising: a mobile sensor for each of the persons; a database for downloading data generated by the mobile sensor and processing the data to compare athletic performances of the multiple persons, the database being accessible through the Internet to review the athletic performances between the persons. Data from the sensors downloads to a database so that users may compare athletic performances (e.g., speed) between the persons, such as through the Internet

U.S. Pat. No. 7,769,613 describes a system and method for estimating the value of athlete using game achievement evaluation model. A game situation is classified into attack addition (contribution), attack subtraction (error), defense addition (contribution) and defense subtraction (error), 129 game factors are defined based on the classified factors, the assignment principle is set, the game factors are sub-classified into 1277 game situation factors, and the game factors and the game situation factors are given with weights, unlike quantity-based record evaluation by an existing athlete contribution evaluation method. The existing record input method is dependent upon quantitative record only, and thus does not include situation information on how player plays a game under what situation.

U.S. Pat. No. 7,771,320 claims an athletic performance sensing and/or tracking system and method. Such systems may include components for sensing athletic performance data and/or for storing and displaying desired information to the user. Systems in accordance with at least some aspects of this invention facilitate transfer of athletic performance data from the performance sensing system to a processing system and/or a display device, e.g., to enable data input, storage, analysis, and/or display on or by an electronic display device, including on or by conventional electronic display devices that are known and commercially available.

United State Patent Publication No: 2010/0185398 describes a system and method for monitoring athletic performance. A system for monitoring biometric data of an athlete participating in a sporting event comprises at least one biometric sensor carried by the athlete. The biometric data is collected using a sensor positioned on an athlete participating in a sporting event; wirelessly transferring the collected biometric data to a computer in real time using a wireless telephony network; and processing the biometric data at the computer. The processed biometric data for the sporting event is available to the athlete or other authorized individuals in real time and/or any time following the sporting event at a computer connected to the Internet.

United State Patent Publication No: 2010/0204615 claims a method and system for collecting acceleration and rotation data and extracting features which relate to athletic performance there from. A system for assessing athletic performance comprises a mounting device wearable by an athlete, a sensing device attachable to the mounting device, and a base unit. The base unit comprises a wireless communication device for receiving the data, a feature extractor for extracting features relating to athletic performance from the data based on a plurality of expected events of the athletic test, and, an output device for outputting the extracted features.

United State Patent Publication No: 2010/0184564 describes a system and method for monitoring player performance during athletic activities including team oriented athletic activities. These systems and methods can provide useful metrics for players and coaches relating to athletic performances in various sports, including various team sports. The systems and methods may be used by the individual as a measuring stick and motivation to improve, as well as by coaches or trainers

United State Patent Publication No: 2002/0116147 describes a method and system for assessing athletic performance. The invention detects the loft time, speed, power and/or drop distance of a vehicle, such as a sporting vehicle, during activities of moving and jumping. The jumping motions, on the other hand, include movements which loft the skier into the air. Generally, the greater the skier's speed, the higher the skier's loft into the air. A loft sensor detects when the vehicle leaves the ground and when the vehicle returns to the ground. A controller subsystem converts the sensed information to determine a loft time. A display shows the recorded loft time to a user of the system. Gaming on the internet is facilitated to connect worldwide sport enthusiasts.

United State Patent Publication No: 2010/0129780 claims an athleticism rating method for normalizing and more accurately comparing overall athletic performance of at least two athletes. Each athlete completes at least two different athletic performance tests. The method receiving at least two results for the athlete's performance in at least two different athletic performance tests related to the defined sport and comparing each of the at least two results to a corresponding distribution of test results of athletic data for athletes similar to the athlete and determining a percentile ranking for each of the at least two results and transforming the percentile ranking for each of the at least two results to a fractional event point number for each result.

United State Patent Publication No: 2007/0185599 describes a system for ranking sports players. The system display logic operable to display two players from a plurality of players, and selection logic operable to store a selection of one of the two players by a user. The system further includes logic operable to rank the players based upon user selections of the players. The system may pair players, e.g., select a first player and a second player for display and selection by a user, based on their relative rankings. A first player is selected and the second player is selected based on the ranking of the first player such that closely ranked players are paired for selection by users with greater frequency than remotely ranked players.

United State Patent Publication No: 2004/0049469 claims a “ranking system” by noticing a relation between said “foreign language conversation communication ability” and “sports ability” and aims for an improvement of a communication ability in a foreign language. A ranking system comprises a means for entering a sports field or a record or ranking thereof, a means for calculating a sport score from said record or ranking, a means for choosing a language, a means for entering the foreign language conversation communication ability, a means for calculating a language score from said foreign language conversation communication ability, a means for processing a ranking by comparing via network said sport score and said language score with data recorded and accumulated in a network server, and a means for displaying said ranking

United State Patent Publication No: 2008/0015819 describes an athletic performance data system that has an athletic field data collection system for obtaining athletic performance data and athlete identifying information for plural athletes at an athletic performance event. The system provides accurate and reliable identification of the performance data for each athlete, minimizes the manual handling of the data by performance evaluators, and provides prompt uploading of the data for calculation of an athleticism rating. The system provides an athleticism rating for each athlete as a separate web page that can be personalized by the athlete.

However the purpose and methodology of all the above inventions that are part of prior art do not envisage the unique embodiment processing and evaluating the athlete performance in a detailed manner using a wide range spectrum of information and multiple data fields involving logical and mathematical calculations based on the multiple data entries. Accordingly, improvements are needed in the existing methods and structures that negate the above shortcomings.

The present invention overcomes these and other problems by providing a system and process for the evaluation of athlete individual and team performance through calculations based on the answers given by user or team to a set of questions. The player can access his/her scores according to his/her performance in the athlete. Various teams and its players can be evaluated through this system. The data fields are easily understandable. This system allows processing of information and viewing of information in various modes and different perspectives according to the players and teams.

Further it will be apparent to those skilled in the art that the objects of this invention have been achieved by providing various a system and process for measuring individual athlete performance and team performance through logical and mathematical data entry, analysis and calculation which is unique in nature unlike existing systems that are suited only for limited purposes. Various changes may be made in and without departing from the concept of this invention. Further, features of some stages disclosed in this application may be employed with features of other stages. Therefore, the scope of the invention is to be determined by the terminology of the following description and the legal equivalents thereof.

### SUMMARY OF THE INVENTION

This present invention may be summarized, at least in part, with reference to its objects.

The foremost object of this invention is to evaluate athlete performance through logical and mathematical data entry, analysis and calculation.

Another object of the present invention is to evaluate team performance through logical and mathematical data entry, analysis and calculation.

Another object of the present invention is to analyze athlete or team performance through the answer given by user to a multiple set of questions in various data fields.

Another object of the present invention is to analyze athlete or team performance through the logical and mathematical analysis of the data field entries.

Another object of the present invention is to analyze individual and team athlete performance related to any kind of sport.

Another object of the present invention is to allow athletes or teams to monitor their individual or team performance level.

A further object of the present invention is to allow athletes or teams to improve their performance by comparing the other player's or team's performance level.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description, and in part will become apparent to those skilled in the art upon examination of the following, or may be learned by practice of the invention.

### DESCRIPTION OF THE DRAWINGS

FIG. 1 is a data diagram of the present invention.

FIG. 2 is is a data diagram of the present invention.

FIG. 3 is a data diagram of the present invention.

### DETAILED DESCRIPTION OF THE INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

The following description is presented to enable any person skilled in the art to make and use the invention, and is provided in the context of particular applications of the invention and their requirements. The present invention can be configured as follows:

The present invention comprises of a system and process for evaluation of athlete performance where the player can evaluate their performance like score, ranking, position and level. The present system and process measures the athlete's present performance and not entirely based on his past record.

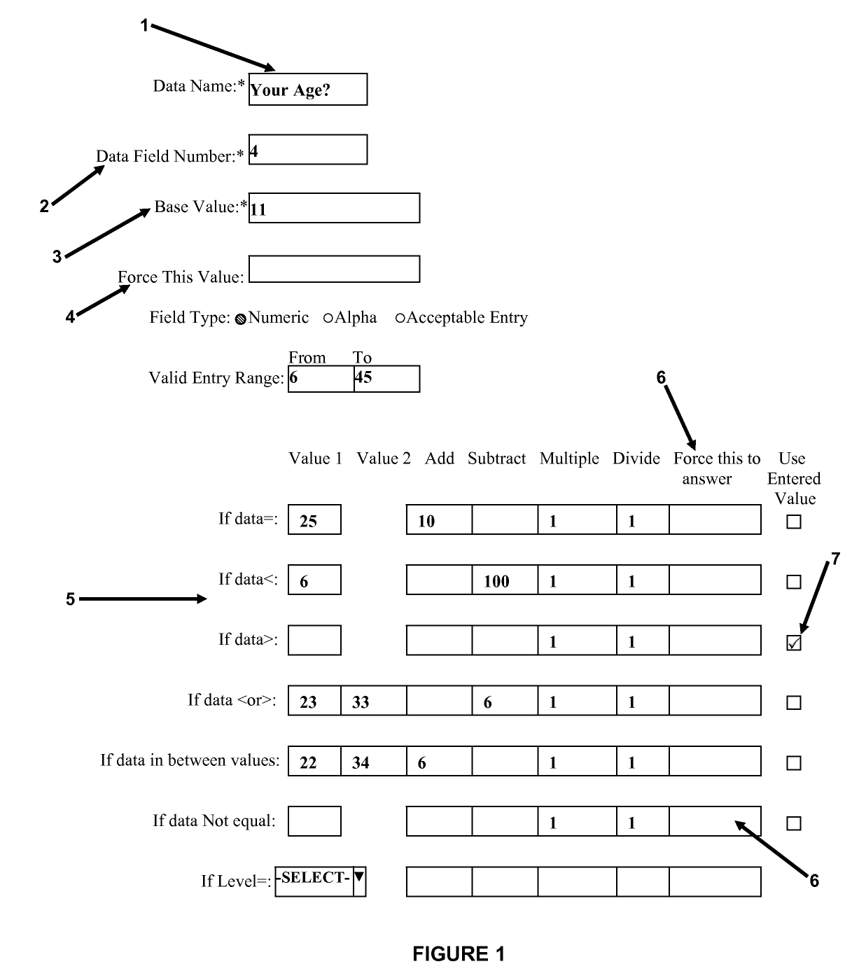

In a preferred embodiment of the present system and process, a user or a team has to answer a set of questions specifically to that sport or specifically to the athlete role/position on the team. As per FIG. 1, the user is presented by a set of questions (1) depending on his position, if he is part of a team, or an individual athlete. The question may be related but not limited to the physical condition of the athlete, medical issues of the athlete, psychological condition of the athlete, last event performance of the athlete, the personal environment of the athlete, relationship of athlete with coaches. The present invention not only measures the athlete performance but also displays the legal contract issue, drugs related issues, criminal related issues, media/news controversy, drug and criminal related issues, athletic record, etc. If it is a team, the present system and process also takes into account parameters such as team performance, the athlete relations with other team members, effect of other team members on his performance (if it is a team sport), effect of the entire team on his performance, effect of other positions/role on his job performance, etc.

Every data field must have an assigned number assigned by the questionnaire user; which is unique to that template only. That field number could be used in different template (2). A Base Value or “Weight” is allotted to every question (3).

Based on the above questions, the system calculates through complex logic (5), a score and presented on a chart for visual presentation. The score of every individual question could be calculated using this value, or we could use what the user entered as a base for the calculations (7). The user can force an answer, a value for the entire field irrespective of the outcome of the calculations (4).

The user can force a certain line of calculations a value, by entering an amount here. The answer to that line of calculation will be ignored and the forced value in this field will be considered. (6) If the boxes are checked (7), the user can use the value that is entered by the user, overriding the base value (3).

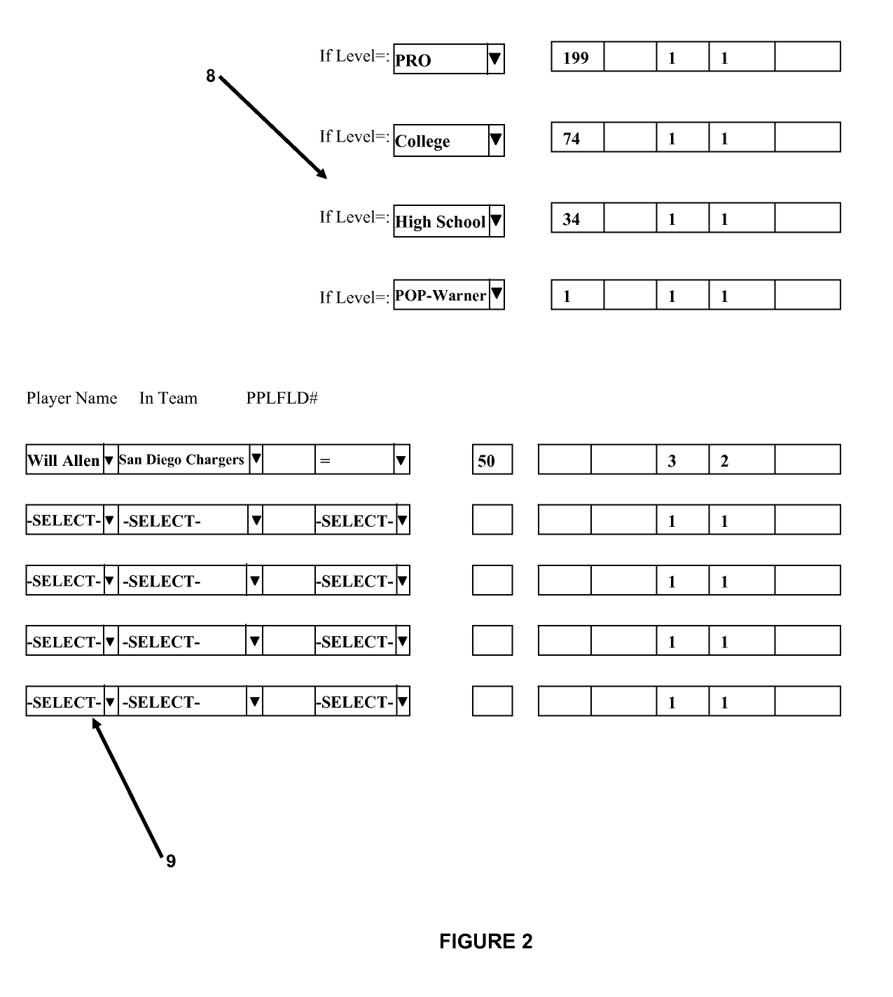

As per FIG. 2 in a preferred embodiment of the present system and process, the user can assign a value to the level of the athlete (8). For example a PRO athlete can be given a higher score, measurement, than a high school athlete. The user can also use another athlete's template to influence the results of an athlete's position (9).

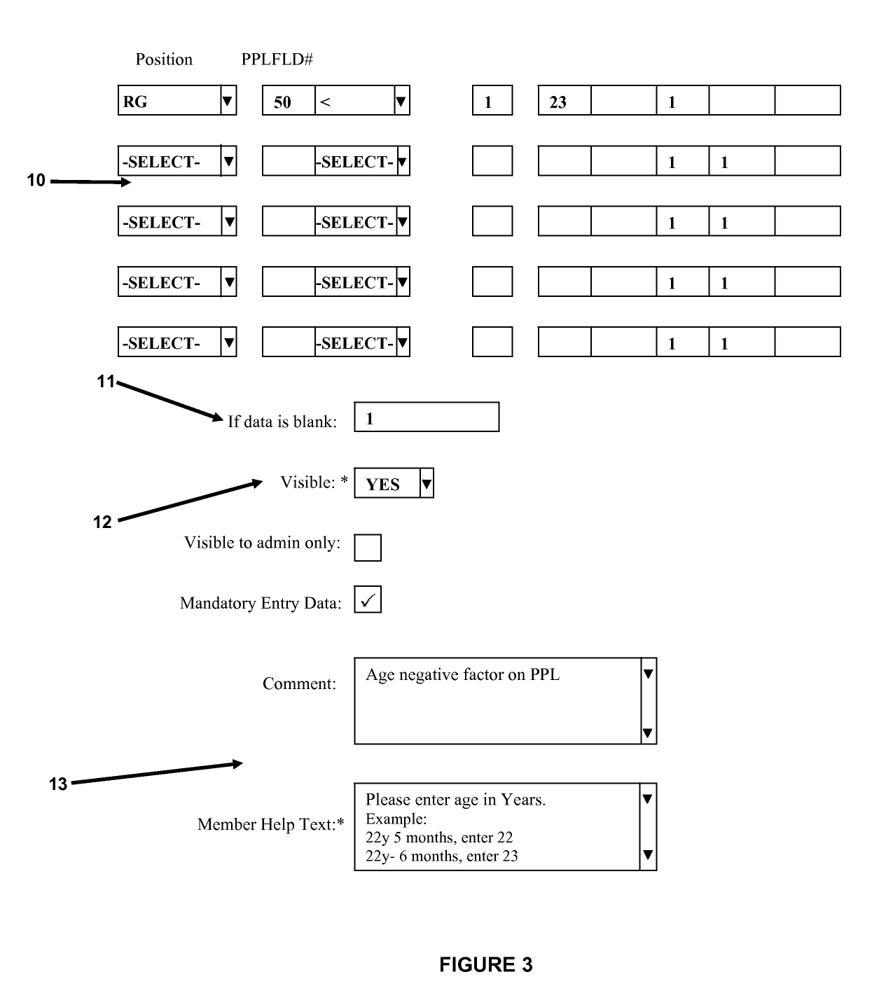

As per FIG. 3, in a preferred embodiment of the present system and process, the user can use other fields to form another template to influence the results of the given template (10). For example a catcher position on a team could have an influence on and affect the passer's performance. The fields from the catcher's template can be used to influence the results of the passer's template. A value can be forced if no data is entered and left blank (11). Questions that are not required can be made invisible if they are not relevant and no data needs to be entered (12). The user can enter instructions as notes (13). The second box may contain instructions to the user on how best to answer a certain question (13).

Once all entries are complete and values are assigned, the value of each data field is added. The total obtained by such addition of values is the athlete level or score. This score can also be visually presented on a graph by the present invention.

Through the present system and process the user if an athlete can monitor their individual performance level and also their team's performance. This will help the players to improve their performance by comparing the other player's performance level. The player can determine the drawback on his performance. The present invention can be used for any kind of sport and also can be used to measure the entire team as a one unit.

Further is outlined in general, the physical aspects of the present invention, to serve as an aid to better understanding the intended use and application of the present invention. The invention may be embodied by a computer program product embodied in a computer readable medium for processing and displaying the data fields of the present invention, comprising one or a plurality of computers configured to receive data on a plurality of questions, one or a plurality of data storage devices configured to store the questions and related data and one or a plurality of display units configured to create a display of the said data fields using the standardized visual display characteristics and showing name/title and one or more of the following predefined information categories, and that is executed by a processor within a computer as a series of computer executable instructions. The examples of encryption and decryption specifically point out preferred embodiments of the present invention, and are not to be construed as limiting in any way the remainder of the disclosure. Various user computers configured to operate in a distributed computer system network are connected to a plurality of web servers by means of the Internet. The web pages are maintained in the web servers and are downloaded to user computers by means of the Internet.

Such examples are non-limiting in that one of ordinary skill (in view of the above) will readily envision other permutations and variations on the invention without departing from the principal concepts. Such permutations and variations are also within the scope of the present invention.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of this invention have been achieved by providing the above invention. However various changes may be made in the structure of the invention without departing from the concept of the invention. Therefore, the scope of the invention is to be determined by the terminology of the above description and the legal equivalents thereof.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A computer-implemented system and process for evaluation of athlete performance comprising the steps of:
receiving data on a plurality of information in the form of questions;
receiving data on a plurality of relationships among the said information;
receiving data on a logical classification of the said information and the said relationships among said information;
applying interpretive logic to standardize the said data;
applying standardizing rules to generate the visual display characteristics of said data based on their logical classification applying values to said data once all entries are complete adding said values assigned to said data
characterized in that the total obtained by addition of said values is the athlete level or score, the visual display characteristics of said score being laid out in a graph.

2. The computer-implemented system and process as claimed in claim 1 wherein the user is presented by said questions depending on his position as part of a team or an individual athlete.

3. The computer-implemented system and process as claimed in claim 1 wherein said information in the form of said questions are one or both of fact/opinion and both individual or comparative.

4. The computer-implemented system and process as claimed in claim 1 wherein said question as applied to an individual athlete may include but not limited to the physical condition, medical issues, psychological condition, last event performance, personal environment, relationship with coaches, legal contract issue, drugs related issues, criminal related issues, media/news controversy, and athletic record.

5. The computer-implemented system and process as claimed in claim 1 wherein said question as applied to an individual athlete may include but not limited to team performance, relations with other team members, effect of other team members on individual athlete performance, effect of the entire team on individual athlete performance, and effect of other positions/role on athlete performance.

6. The computer-implemented system and process as claimed in claim 1 wherein said data field has a unique number assigned by the user and that may be used in a different template.

7. The computer-implemented system and process as claimed in claim 1 wherein a base value or weight is allotted to each said question.

8. The computer-implemented system and process as claimed in claim 1 wherein a logical classification of the said information and the said relationships among said information is made by applying interpretive logic to standardize the said data, said data being presented on a chart for visual presentation.

9. The computer-implemented system and process as claimed in claim 1 wherein said score of each said question may be calculated using said value, or the user entry as a base for the calculations may be used.

10. The computer-implemented system and process as claimed in claim 1 wherein said user can force an answer through applying a value for the entire field irrespective of the outcome of the calculations.

11. The computer-implemented system and process as claimed in claim 1 wherein said user can force a certain line of calculations by entering a value, the answer to that line of calculation being ignored and said forced value being considered for further calculation.

12. The computer-implemented system and process as claimed in claim 1 wherein if the boxes are checked, said user can use the value that is entered by him, overriding the base value.

13. The computer-implemented system and process as claimed in claim 1 wherein said user can assign a value to the level of the athlete or use another athlete's template to influence the results of an athlete's position.

14. The computer-implemented system and process as claimed in claim 1 wherein said user can use other fields to form another template to influence the results of the given template.

15. The computer-implemented system and process as claimed in claim 1 wherein said questions that are not required can be made invisible if they are not relevant and no data needs to be entered.

16. The computer-implemented system and process as claimed in claim 1 wherein said user can enter instructions as notes, said system further containing instructions to said user on how best to answer a certain question.

17. The computer-implemented system and process as claimed in claim 1 wherein on completion of said entries and assigning of values, the value of each data field is added, total of said values being the athlete level or score.

18. A computer-implemented system and process as claimed in claim 1 comprising at least one computer configured to:
receive data on a plurality of information in the form of questions;
receive data on a plurality of relationships among the said information;
receive data on a logical classification of the said information and the said relationships among said information;
apply interpretive logic to standardize the said data;
apply standardizing rules to generate the visual display characteristics of said data based on their logical classification
apply values to said data once all entries are complete
add said values assigned to said data
obtain a total athlete level or score by addition of said values.

19. The computer-implemented system and process as claimed in claim 1, wherein at least one computer is configured to operate in a distributed computer system network.

20. A computer program product embodied in a computer readable medium for processing and displaying the system and process of claim 1.
